(19) United States
(12) Patent Application Publication
(10) Pub. No.: US 2006/0283674 A1
(43) Pub. Date: Dec. 21, 2006

(54) Shock absorber and spring element for a shock absorber

(76) Inventor: Uwe Klein, Wuppertal (DE)

Correspondence Address: JORDAN AND HAMBURG LLP, 122 EAST 42ND STREET, SUITE 4000, NEW YORK, NY, 10168, US

(21) Appl. No.: 11/455,496

(22) Filed: Jun. 19, 2006

(30) Foreign Application Priority Data
Jun. 18, 2005 (DE) 10 2005 028 302.0
May 13, 2006 (DE) 10 2006 022 490.6

(51) Int. Cl. F16F 9/48

(52) U.S. Cl. 188/284

(57) ABSTRACT

Shock absorber, at least containing a damping tube, a piston rod, a sealing element for the damping tube, and a metal compression spring that surrounds the piston rod, characterized in that a compression spring provided with a linear rate is switched in series with a spring element comprising elastomer or plastic material and having a progressive rate, whereby the spring element is embodied on the compression spring side like a spring retainer at least partially guiding the compression spring and is embodied outside of the spring retainer at least in part like a bellows.

The invention relates to a shock absorber, in particular that can be employed in a motor vehicle, in accordance with the generic portion of the first patent claim.

DE-C 35 10 866 describes a hydraulic twin-tube vibration damper that contains inside a cylindrically embodied tube a guided compression stop spring that is supported at one end on a control plate, whereby another support spring is provided axially outside of the control plate.

Found in DE-A 31 51 771 is a hollow bump stop that surrounds a piston rod of a vibration damper for a motor vehicle and that comprises a bellows made of solid elastomer material, in particular rubber. The individual folds have different shapes that can be matched to the desired spring characteristics. In addition, provided at each fold is an interior guide element that is positioned against the piston rod and that can be formed by a guide knob or guide ring. The bump stop is provided outside of the actual vibration damper.

A spring element is found in DE-Gbm 203 07 898 that is based on a cylindrical damping element that is based on polyisocyanate polyaddition products and that has a surrounding base having a diameter of 131 to 135 mm and a thickness of 2 to 10 mm, as well as a head part with a diameter of 54 to 56 mm. The closure to the head part is embodied in the shape of a convex lens.

If for example a hydraulic shock absorber is employed as is described in DE-C 35 10 866, it can occur that, if the individual turns of the compression springs provided with a linear rate touch one another, (spring goes onto block), interfering and therefore undesired noises occur at the stop limits. In order to suppress these noises, separate spring elements must be inserted between stop surface and spring retainer.

A vibration damper with a mechanical tension stop is known from DE-A 44 08 405. A stop body is used that comprises plastic, comprising a shell and a flange, and forms a reclosable connection with the spring. The sleeve has on its interior diameter at least one radial guide surface opposing a piston rod. There are no spring properties in this stop body, particularly acting in the longitudinal direction of the piston rod.

The underlying object of the invention is to provide a shock absorber that on the one hand makes do with fewer components while avoiding the disadvantages of the prior art and therefore is simpler and more cost-effective to produce and for which on the other hand a specific spring rate with a certain block size can be deliberately set.

The object of the invention is furthermore to design a spring element that has a simple structural design while ensuring certain support and guidance for the compression spring and that can be used to deliberately set a specific spring rate with a certain block size for specific usages.

This object is attained in that a compression spring provided with a linear rate is switched in series with a spring element comprising elastomer or plastic material and having a progressive rate, whereby the spring element is embodied on the compression spring side like a spring retainer at least partially guiding the compression spring and is embodied outside of the spring retainer at least in part like a bellows.

Advantageous further developments of the inventive shock absorber can be found in the associated subordinate claims.

This object is also attained by a spring element made of elastomer or plastic material that can be used inside a shock absorber, containing a spring area that has a progressive rate and is embodied somewhat like a bellows, as well as a guide area that is provided outside of the spring area and that is embodied molded in one piece thereto like a spring retainer and that is for a metal compression spring provided with a linear rate, whereby the guide area is formed by a radial clamping area and an axial support area for the free end of the compression spring.

Advantageous further developments of the inventive spring element can be found in the associated subordinate claims.

The additional spring element with the progressive rate, which is arranged in series with the compression spring with the linear rate, is simultaneously embodied as a spring retainer on which the one end area of the compression spring with the linear rate is supported. Using this arrangement is possible to do without at least one additional component, specifically the separate spring retainer, reducing the number of parts in the shock absorber and thus attaining a simpler structure for the shock absorber while simultaneously reducing its cost.

The additional spring element provides a clamping area for receiving the compression spring with the linear rate and ensures secure radial guidance of the compression spring on the piston rod. Low-friction axial sliding of the spring retainer on the piston rod is also assured.

Due to the subject of the invention, the overall rate of the compression spring mechanically linked to the additional spring element (switched in series) is thus likewise progressive in the block area. Therefore the spring turns in the compression spring do not contact one another abruptly and noisily but rather quietly and in a cushioned manner. In this manner the transmission of interfering noises at the stop limit into the vehicle interior is prevented.

In accordance with another aspect of the invention, the spring element comprises an elastomer polyether ester (TEEE). Using spring elements matched to the current usage, specific spring rates with a defined block size can be set. The rate can be affected by modifying the bellows area, specifically by changing the wall strength, the length, and the ratio of interior to exterior diameter, and thus can be adjusted to the individual case. It is likewise possible to modify the material strengths of the spring element as needed outside of the bellows area.

It can be advantageous to provide a plurality of radial through-holes on the circumference of the spring element. Any oil that collects in the bellows area can thus be transported radially outward when the spring area is compressed or radially inward when it is extended, not interfering with the functionality of the spring element.

Thus, the subject of the invention involves advantages that can be attained by integrating the following functions in one and the same component:

1. Spring Retainer

a. Receives the compression spring (e.g. using a force fit)

b. Provides stop surface

c. Radial guidance (e.g. on the piston rod)

2. Compression Stop

a. Progressive Spring Rate

The subject of the invention is depicted in the drawings using an exemplary embodiment and is described as follows.

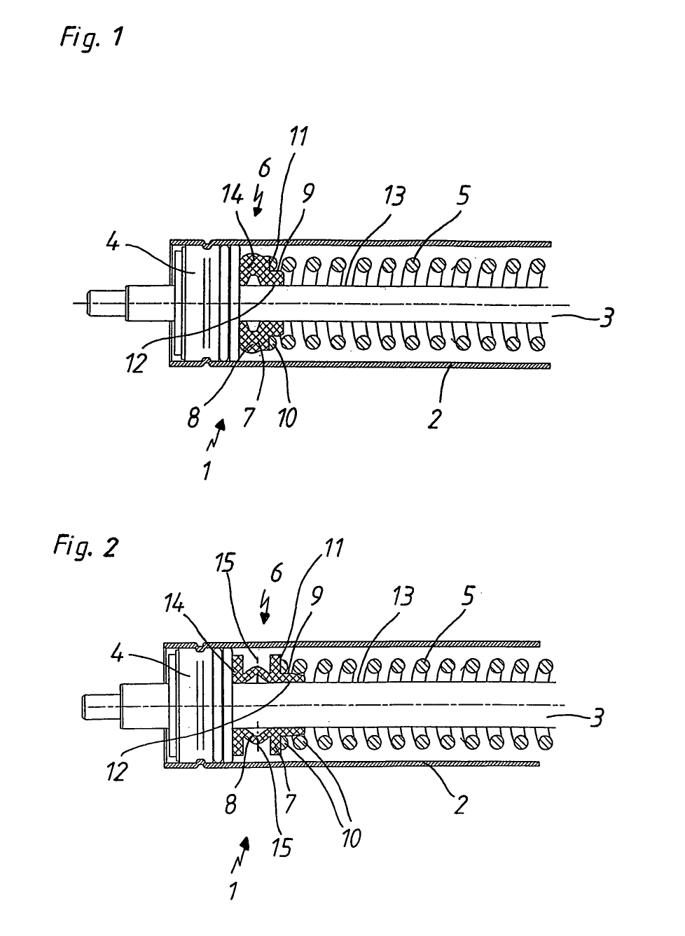

FIGS. 1 and 2 Principle sketches of shock absorbers with differently designed spring elements.

The principal sketch in FIG. 1 merely indicates a shock absorber 1 that can be employed for instance in the area of a vehicle chassis. The shock absorber 1 contains at least one damping tube 2, one piston rod 3, a sealing element 4 for the damping tube 2, a metal compression spring 5 that surrounds the piston rod 3 and that has a linear spring rate, and another spring element 6 that is switched in series therewith, that is axially supported on the sealing element 4, and that has a progressive spring rate. The additional spring element 6 in this example should comprise an elastomer polyether ester (TEEE) and contains a spring retainer 7, a somewhat bellows-like spring area 8 having a progressive rate being molded in one piece thereto.

The spring retainer 7 is embodied such that on the one hand a radial clamping area 9 is provided for at least one spring turn 10 of the compression spring 5 and on the other hand there is an axial support area 11 for this spring turn 10. The radial clamping area 9 can be designed such that it receives the spring turn 10 for instance using a force fit. The interior diameter 12 of the spring retainer 7 is selected such that low-friction axial sliding is assured on the exterior circumferential surface 13 of the piston rod 3. Due to the single-piece design of the spring retainer 7 in connection with the spring area 8, separately embodied spring retainers described in the prior art are not necessary.

FIG. 2 depicts a spring element 6 with an embodiment alternative to that in FIG. 1. Identical elements are provided identical reference numbers. In this case, as well, a spring retainer 7 is provided, to which a somewhat bellows-like spring area 8 is connected that is in one piece and has a progressive rate. This spring area 8 runs on the sealing element side into a bump stop 14 that is embodied corresponding to the spring retainer 7 and that is supported on the sealing element 4. The clamping area 9 for the compression spring 5 is embodied longer than in FIG. 1, so that in this case a second spring turn can also be applied and guided.

The two exemplary embodiments depict differently designed spring areas 8. By deliberately modifying the length of the spring area 8, its radial wall strength, and the ratio of interior to exterior diameter, spring rates with a defined block size can be set that are specifically matched to the current usage. Of particular advantage is the material selection for the spring element 6, since the desired effect cannot be optimally induced with any desired chosen material. In the case of the preferably used material (elastomer polyether ester (TEEE)), special process steps in the manufacturing process can ensure that the material absorbs energy when it is compressed and stores this energy as potential energy/spring energy. When unloaded, the material releases the stored energy so that the restorability of the spring element is comparable to that of a steel spring.

Distributed on the circumference in the spring area 8 are a plurality of through-holes 15 that run radially. Any oil that accumulates in the bellows area can thus be transported radially outward when the spring area is compressed and radially inward when it is extended and does not interfere with the functionality of the spring element.

### LEGEND

1. Shock absorber
2. Damping tube
3. Piston rod
4. Sealing element
5. Compression spring
6. Spring element
7. Retaining spring
8. Spring area
9. Clamping area
10. Spring turn
11. Support area
12. Interior diameter
13. Circumferential surface
14. Bump stop
15. Through-hole

1. A shock absorber comprising:
a damping tube;
a piston rod;
a sealing element for said damping tube; and
a first biasing member, said first biasing member being a metal compression spring that surrounds said piston rod;
said first biasing member being a linear spring;
a second biasing member, said second biasing member being axially disposed in series with said first biasing member;
said second biasing member being an elastomer or plastic material a being a non-linear spring;
said second biasing member including a first portion, said first portion being a retainer for contacting and guiding said first biasing member; and
said second biasing member including a second portion, said second portion defining a bellows shaped spring.

2. The shock absorber of claim 1, wherein said second biasing member is disposed against said sealing element.

3. The shock absorber of claim 1, wherein said second biasing member is disposed around said piston rod.

4. The shock absorber of claim 1, wherein said first portion of said second biasing member includes:
a first segment defining a radially extending clamp; and
a second segment defining an axial support for supporting an end of said first biasing member that faces said second biasing member.

5. The shock absorber of claim 1, wherein said retainer has an interior diameter that enables low-friction axial sliding on said piston rod.

6. The shock absorber of claim 1, wherein a spring rate with a prespecifiable block size of said second shaped portion of said second biasing member is provided by modifying the axial length, the radial wall strength, the ratio of interior to exterior diameter, and/or the material of said second portion.

7. The shock absorber of claim 1, wherein said spring element comprises an elastomer polyether ester (TEEE) material.

8. The shock absorber of claim 1, wherein said first and second segments of said second biasing member are formed as a single piece.

9. A spring element comprising an elastomer or plastic material said spring further comprising:
a first portion that has a non-linear rate and is bellows shaped;
a second portion defining a guide that is provided adjacent to said first portion, said second portion being one piece with said first portion, said second portion including a spring retainer adapted for contacting and guiding a linear rate is for a metal compression spring; and
said second portion including a radial clamping segment and an axial support segment adapted for engaging a free end of said compression spring.

10. The spring element of claim 9, comprising an elastomer polyether ester (TEEE) materail.

11. The spring element of claim 9, wherein a plurality of radially extending through-holes are circumferentially disposed about said first portion of said spring.
